(19) United States
(12) Patent Application Publication
(10) Pub. No.: US 2025/0252482 A1
(43) Pub. Date: Aug. 7, 2025

(54) SYSTEMS AND METHODS FOR ENHANCING MOBILE SHOPPING EXPERIENCE

(71) Applicant: Locker 2.0, Inc., Glendale, CA (US)

(72) Inventors: Kristine Elizabeth Locker, Glendale, CA (US); Taylor Michel, Ocala, FL (US)

(21) Appl. No.: 18/431,846

(22) Filed: Feb. 2, 2024

(51) Int. Cl. G06Q 30/0601; G06F 21/62

(52) U.S. Cl. CPC G06Q 30/0641; G06F 21/629

(57) ABSTRACT

A system includes a processor that executes instructions stored in memory to: receive a request from a user device to access an external function on a webpage; confirm access to the external function by: communicating with a server providing the external function for an authentication token; receiving an authentication token used to access the server providing the external function; synchronizing the authentication token of the external function to a web browser displaying the webpage; authorizing access to the external function on the webpage; and retrieving information from the server to include in the external function; retrieve an image payload from the webpage, the image payload including information related to one or more images; determine a display image from the image payload to display in the external function; populate the external function using the display image and the information from the server; and overlay the external function on the webpage.

### BACKGROUND

### 1. Field

Aspects of one or more embodiments of the present disclosure relate to systems and methods for saving and sharing products offered on webpages, and more particularly, a shared authenticated session for presenting a sharing function for a product image of a product offered on the webpages, and methods including the same.

### 2. Description of Related Art

Mobile device browsers allow additional actions on a webpage through a share functionality. Mobile device browsers allow a webpage and its URL to be transmitted/shared with other applications on the mobile device and processed by an application. Mobile device browsers also include browser plugins and extensions to define the additional actions to perform on a webpage. Browser plugins and extensions add various functions to a browser to enable the browser to manage internet content that the browser is not designed to process. Mobile browser share screens allow the inclusion of some of these functions directly to the existing sharing function based on the application selected for sharing the internet content presented in a web browser.

The above information disclosed in this Background section is for the enhancement of understanding of the background of the present disclosure, and therefore, it may contain information that does not constitute prior art.

### SUMMARY

One or more embodiments of the present disclosure are directed to systems and methods for accessing an external function (e.g., a saving function) to save a display image (e.g., a product image) from among a plurality of images of a webpage.

According to one or more embodiments of the present disclosure, a system for accessing an external function on a webpage, includes: one or more processors; and memory communicably connected to the one or more processors and storing instructions that, when executed by the one or more processors, cause the one or more processors to: receive a request from a user device to access the external function on the webpage; confirm access to the external function by: communicating with a server providing the external function for an authentication token; receiving an authentication token used to access the server providing the external function; synchronizing the authentication token of the external function to a web browser displaying the webpage; authorizing access to the external function on the webpage; and retrieving information from the server to include in the external function; retrieve an image payload from the webpage, the image payload including information related to one or more images; determine a display image from the image payload to display in the external function; populate the external function using the display image and the information from the server; and overlay the external function on the webpage.

In an embodiment, to retrieve the image payload from the webpage, the instructions may further cause the one or more processors to: determine a first set of images in the webpage displayed on the user device; determine a second set of one or more images presented on the webpage displayed in the web browser; and add the first set and second set of one or more images to the image payload.

In an embodiment, to determine the first set of images in the webpage displayed on the user device, the instructions may further cause the one or more processors to: determine a viewport of the webpage as visible on the user device; determine nine points on the viewport to identify a primary image visible in the viewport of the user device; identify a primary image intersecting with one or more of the nine points on the viewport of the user device; and add the primary image to the first set of one or more images.

In an embodiment, to determine the display image from the image payload to display in the external function, the instructions may further cause the one or more processors to: determine code in the webpage to display the one or more images in the image payload; determine file sources of each image of the one or more images in the code, the file sources identifying locations of files representing each image of the one or more images; access the one or more images from the file sources; validate each image of the one or more images by reviewing an image size and a visibility of the image; de-duplicate the validated images by determining whether each image is a duplicate of any previously validated images; and determine the display image from the de-duplicated images.

In an embodiment, to determine the code in the webpage to display the one or more images in the image payload, the instructions may further cause the one or more processors to: determine image elements of an HTML code of the webpage where the one or more images are located; determine other elements of the HTML code of the webpage which sets background image attributes where the one or more images are located; and determine elements of a hidden portion of the HTML code of the webpage present where the one or more images are located. The hidden portion of the HTML code may be a dynamically generated code.

In an embodiment, to access the one or more images from the file sources, the instructions may further cause the one or more processors to: determine source attribute of the image elements of the HTML code of the webpage where the one or more images are located; and in response to the source attribute being empty, determine alternative attributes representing the file sources.

In an embodiment, the request from the user device to access the external function on the webpage may be received in response to a user of the user device selecting a share operation.

In an embodiment, to communicate with the server providing the external function for an authentication token, the instructions may further cause the one or more processors to: redirect to an application providing the external function; and in response to no active login session to the application: present a login screen to authenticate access to the application; receive and submit login credentials to authenticate access; receive an authentication token; and return to the web browser to access the authentication token.

In an embodiment, to synchronize the authentication token of the external function to the web browser displaying the webpage, the instructions may further cause the one or more processors to copy the authentication token to a private keychain accessible to the application and the external function.

In an embodiment, to determine the display image from the image payload to display in the external function, the instructions may further cause the one or more processors to: prepare a third set of images included in an order in which they were determined from the webpage; provide a function to select an image from the third set of images; and display a first image in the third set of images.

According to one or more embodiments of the present application, a method for accessing an external function on a webpage, includes: receiving, by a processor, a request from a user device to access the external function on the webpage; confirming, by the processor, access to the external function by: communicating with a server providing the external function for an authentication token; receiving an authentication token used to access the server providing the external function; synchronizing the authentication token of the external function to a web browser displaying the webpage; authorizing access to the external function on the webpage; and retrieving information from the server to include in the external function; retrieving, by the processor, an image payload from the webpage including information related to one or more images; determining, by the processor, a display image from the image payload to display in the external function; populating, by the processor, the external function using the display image and the information from the server; and overlaying, by the processor, the external function on the webpage.

In an embodiment, the retrieving of the image payload from the webpage may include: determining, by the processor, a first set of images in the webpage displayed on the user device; determining, by the processor, a second set of one or more images presented on the webpage displayed in the web browser; and adding, by the processor, the first set and second set of one or more images to the image payload.

In an embodiment, the determining of the first set of images in the webpage viewed by a user of the user device may include: determining, by the processor, a viewport of the webpage as visible on the user device; determining, by the processor, nine points on the viewport to identify a primary image visible in the viewport of the user device; identifying, by the processor, a primary image intersecting with one or more of the nine points on the viewport of the user device; and adding, by the processor, the primary image to the first set of one or more images.

In an embodiment, the determining of the display image from the image payload to display in the external function may include: determining, by the processor, code in the webpage to display the one or more images in the image payload; determining, by the processor, file sources of each image of the one or more images in the code, the file sources identifying locations of files representing each image of the one or more images; accessing, by the processor, the one or more images from the file sources; validating, by the processor, each image of the one or more images by reviewing an image size and visibility of the image; de-duplicating, by the processor, the validated images by determining whether each image is a duplicate of any previously validated images; and determining, by the processor, the display image from the de-duplicated images.

In an embodiment, the determining of the code in the webpage to display the one or more images in the image payload may include: determining, by the processor, image elements of an HTML code of the webpage where the one or more images are located; determining, by the processor, other elements of the HTML code of the webpage which sets background image attributes where the one or more images are located; and determining, by the processor, elements of a hidden portion of the HTML code of the webpage present where the one or more images are located. The hidden portion of the HTML code may be a dynamically generated code.

In an embodiment, the accessing of the one or more images from the file sources may further include: determining, by the processor, source attribute of the image elements of the HTML code of the webpage where the one or more images are located; and in response to the source attribute being empty, determining, by the processor, alternative attributes representing the file source.

In an embodiment, the receiving of the request from the user device to access the external function on the webpage may be in response to a user of the user device selecting a share operation.

In an embodiment, the communicating with the server providing the external function for an authentication token may include: redirecting, by the processor, to an application providing the external function; and in response to no active login session to the application: presenting, by the processor, a login screen to authenticate access to the application; receiving and submitting, by the processor, login credentials to authenticate access; receiving, by the processor, an authentication token; and returning, by the processor, to the web browser to access the authentication token.

In an embodiment, the synchronizing of the authentication token of the external function to the web browser displaying the webpage may include copying, by the processor, the authentication token to a private keychain accessible to the application and the external function.

In an embodiment, the determining of the display image from the image payload to display in the external function may include: preparing, by the processor, a third set of images included in an order in which they were determined from the webpage; providing, by the processor, a function to select an image from the third set of images; and displaying, by the processor, a first image in the third set of images.

### BRIEF DESCRIPTION OF THE DRAWINGS

The above and other aspects and features of the present disclosure will be more clearly understood from the following detailed description of the illustrative, non-limiting example embodiments with reference to the accompanying drawings.

FIG. 1 illustrates a block diagram of sharing system 100 according to one or more embodiments of the present disclosure.

FIG. 2 illustrates a flow diagram of a method of accessing external function for a product listed on a requested webpage according to one or more embodiments of the present disclosure.

FIG. 3 illustrates a flow diagram of a method of confirming access to an external function according to one or more embodiments of the present disclosure.

FIG. 4 illustrates a flow diagram of a method of obtaining access to an external function according to one or more embodiments of the present disclosure.

FIG. 5 illustrates a schematic diagram of a webpage as rendered on a user device according to one or more embodiments of the present disclosure.

FIG. 6 illustrates a flow diagram of a method of accessing images of a product on a webpage to share according to one or more embodiments of the present disclosure.

FIG. 7 illustrates a flow diagram of a method of identifying images on a webpage visible on a device according to one or more embodiments of the present disclosure.

FIG. 8 illustrates a flow diagram of a method of identifying images on a webpage according to one or more embodiments of the present disclosure.

FIGS. 9A-9C illustrate variations of a nine-point technique for identifying images of a product on a webpage requested to be shared according to one or more embodiments of the present disclosure.

FIG. 10A illustrates a schematic diagram of a flow of a share functionality on a webpage according to one or more embodiments of the present disclosure.

FIG. 10B illustrates a schematic diagram of a flow of a share functionality on a webpage according to one or more embodiments of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer, or section from another element, component, region, layer, or section. Thus, a first element, component, region, layer, or section described below could be termed a second element, component, region, layer, or section without departing from the spirit and scope of the present disclosure.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, “and/or” includes any and all combinations of one or more of the listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof.

As used herein, the terms “substantially,” “about,” and similar terms are used as terms of approximation and not as terms of degree and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

The electronic or electric devices (e.g., device, processing circuit, server, and/or the like) and/or any other relevant devices or components according to embodiments of the present disclosure described herein may be implemented utilizing any suitable hardware, firmware (e.g., an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread running on one or more processors in one or more computing devices, executing computer program instructions, and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

One or more example embodiments of the present disclosure may be directed to a browser plugin/extension for showing a sharing and saving function (e.g., an external function) of a product image of a webpage. Generally, images of a webpage may be hosted by a webpage server, such that the images may be retrieved by a browser of a user device via a Uniform Resource Locator (URL) and/or an image file name of the image contained in the hypertext markup language (HTML) and/or extensible markup language (XML) of the webpage. While the images of a webpage may be identified via an image tag or an image file extension in the HTML and/or XML of the webpage, the image content and/or purpose of the image may not be easily identified, as different content providers may use different naming conventions, file structures, and/or the like to designate different types of images for different purposes. For example, a webpage may include various different types of images such as logo images, banner images, button images, thumbnail images, product images, and/or the like, which may be hosted by the webpage server and managed by a third-party content provider. Accordingly, it may be difficult to identify the product images contained in a webpage from among the various different types of images contained in the webpage. As used herein, a product image is an image of a product featured or offered on a webpage (e.g., a product webpage).

Thus, while some browser plugins and extensions may allow the use of a share function with images on a webpage, they may be unable to distinguish between different types of images on different web pages that are managed by different third-party content providers. Therefore, these browser plugins and extensions may allow the share function for all or most of the images contained in a webpage, irrespective of the type or content of the images, which may reduce the aesthetics and/or user experience of the webpage.

According to one or more embodiments of the present disclosure, a system including a browser plugin/extension and a method thereof may be provided that may identify and distinguish a display image (e.g., a product image or other desired image type) from other images contained in a webpage, and may populate it in a Ul for an external function (e.g., saving and sharing function or other suitable function that the browser is not designed to perform) to the product image (or other desired image type) while omitting the external function use on other images (e.g., non-product images) contained in the webpage. The recommendation function may enable the user to save a particular product image for later retrieval of a product webpage containing the product image and/or may enable the user to recommend a particular product image to another user, such that the other user may later retrieve the product webpage containing the product image via the recommendation.

The systems and methods described herein improve computer-related technologies by performing certain processes and methods that cannot be done by conventional browsers or human actors. For example, the systems and methods described herein provide a technical solution to a problem that is necessarily rooted in internet-centric technologies, that is, the ability to add a functionality to a browser in order to distinguish certain images from other images contained in a webpage managed by a third party, and to append the external function to only the certain images of the webpage in real or near real time (e.g., in response to an HTTP POST from the webpage server hosting the webpage) while omitting the external function on the other images contained in the webpage. In some embodiments, the external function (e.g., the recommendation function) may provide a link to an application/web server to enable various functionalities of the browser plugin/extension, which cannot be performed by a browser alone, for example, such as collecting recommendations via the browser plugin/extension from various webpages, and transmitting recommendations to other known users while preventing or substantially preventing the user from providing (e.g., from spamming) the recommendation to unknown users. Accordingly, functionalities of a browser may be improved, and aesthetics and/or a user experience of a webpage that is managed by a third-party content provider and displayed by the browser may be improved.

For convenience, while product images are described in more detail hereinafter as a desired image type (e.g., a display image) to be distinguished from other image types, the present disclosure is not limited thereto, and any desired image type from among the various different types of images contained in a requested webpage may be distinguished, such that a suitable external function (e.g., a recommendation function) may be appended to the desired image type while omitting the suitable function on other images contained in the webpage.

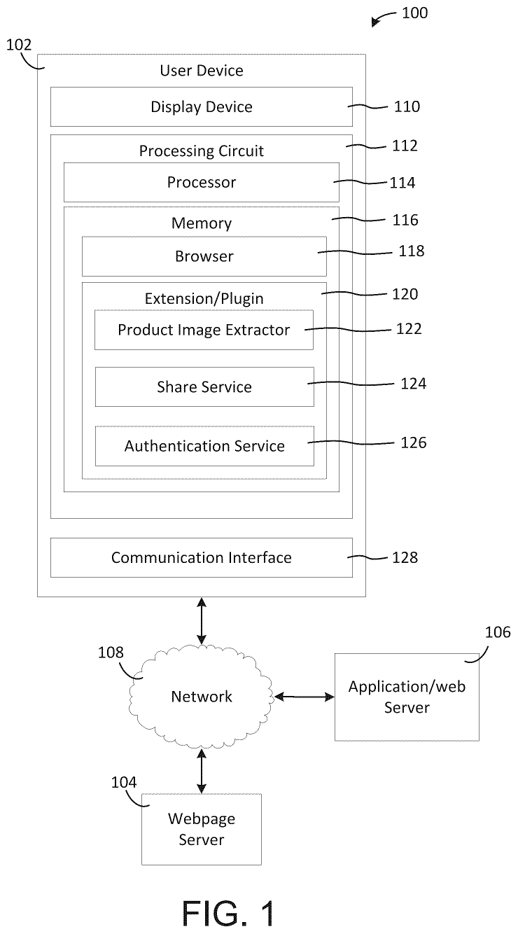

FIG. 1 illustrates a block diagram of a sharing system 100 according to one or more embodiments of the present disclosure.

Referring to FIG. 1, the sharing system 100 may include a user device 102 that is communicably connected to a webpage server 104 and an application/web server 106 over a communications network 108. A browser 118 of the user device 102 may communicate with the webpage server 104 over the communications network 108 to request a webpage to be displayed on a display device 110 connected to or included in the user device 102. The browser 118 may include any suitable internet browser, for example, such as Chrome®, Internet Explorer®, Firefox®, Safari®, Opera®, and the like. However, the present disclosure is not limited thereto, and in other embodiments, the user device 102 may include any suitable program, application, widget, user interface, and/or the like to enable the user device 102 to access the webpage server 104 to request content (e.g., webpages) to be displayed on the display device 110 associated with (e.g., connected to or included in) the user device 102.

The user device 102 may include a processing circuit 112 having a processor 114 and memory 116, and a communication interface 128 for communicating with the webpage server 104 and/or the application/web server 106 over the communications network 108. In various embodiments, the processor 114 may include a general-purpose processor, an Application Specific Integrated Circuit (ASIC), one or more Field Programmable Gate Arrays (FPGAs), a Digital Signal Processor (DSP), any other suitable electronic processing components, or combinations thereof. The memory 116 may include tangible, non-transient, volatile memory, or non-volatile memory, for example, such as Random Access Memory (RAM), Read-Only Memory (ROM), Non-volatile RAM (NVRAM), Flash Memory, hard disk storage, any other suitable electronic storage medium, or combinations thereof. The memory 116 stores instructions (e.g., data, computer code, and/or programming logic) that, when executed by the processor 114, controls the operations of the user device 102. Accordingly, the memory 116 includes database components, object code components, script components, and/or any other type of information structure for supporting the various activities and information structures described herein.

As shown in FIG. 1, in some embodiments, the memory 116 includes the browser 118 and a browser extension/plugin 120. The browser 118 communicates with the webpage server 104 over the communications network 108 (e.g., via the communication interface 128) to request one or more webpages for display on the display device 110. For example, the browser 118 may transmit (e.g., via a URL, an IP address, and/or the like) a request (e.g., HTTP GET) to the webpage server 104 for a requested webpage, and may receive a response (e.g., HTTP POST) from the webpage server 104 including code (e.g., HTML, XML, and/or the like) corresponding to the requested webpage. Browser 118 interprets the code, retrieves any images according to the code (e.g., according to URLs or other suitable links to the images contained in the code), and displays the requested webpage, including the retrieved images on the display device 110, according to the code.

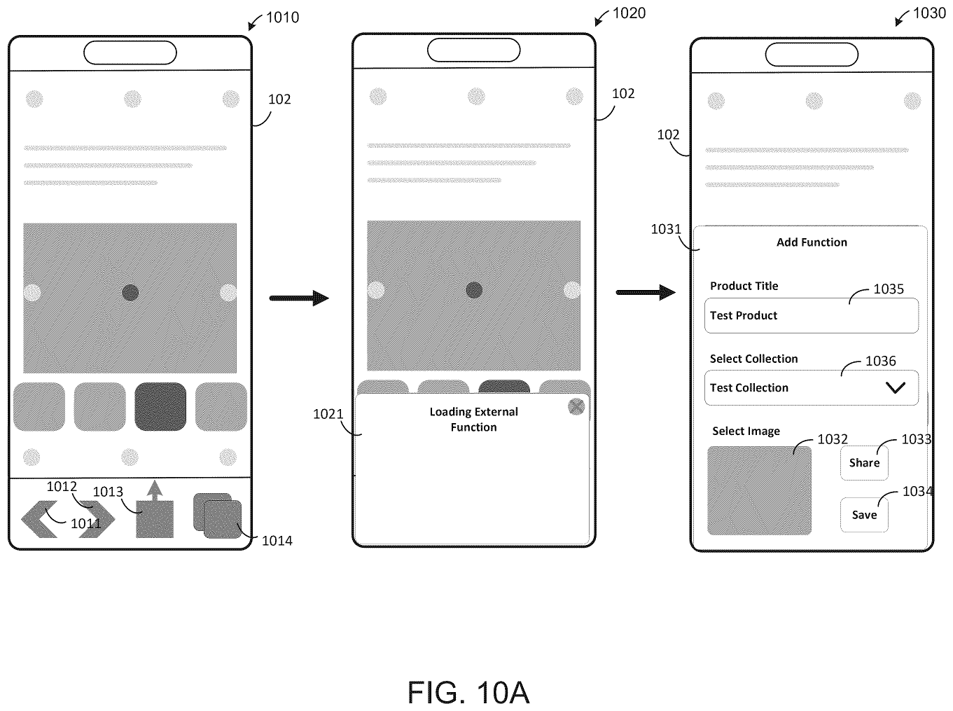

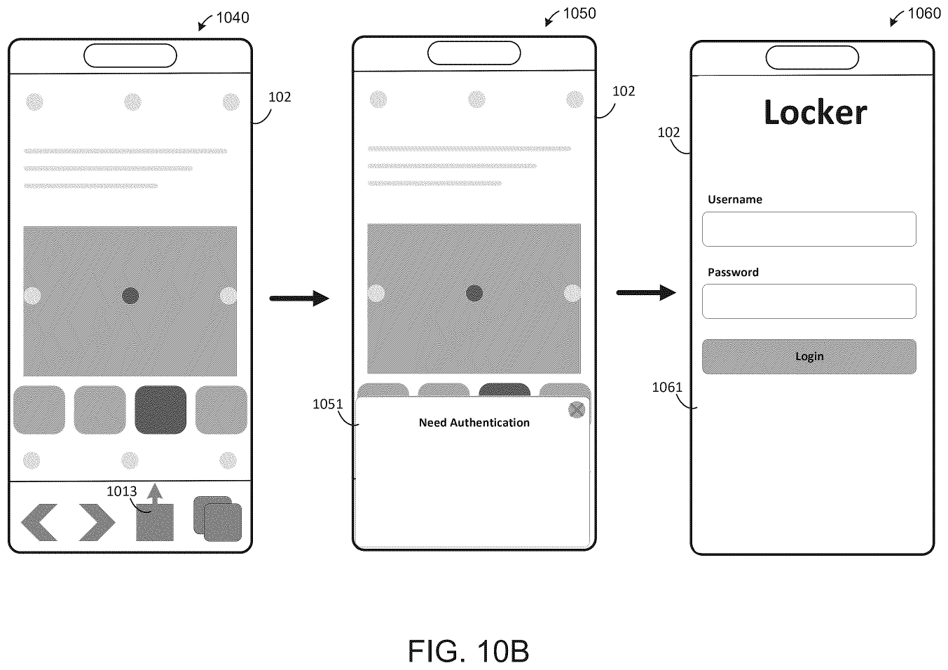

The extension/plugin 120, which may be installed (e.g., loaded or downloaded) into the memory 116 as part of an application installation on a mobile device acting as a user device. For example, in iOS-installed Apple devices (i.e., iPhone, iPad, Macintosh devices), extensions are part of an app installed on iOS devices to provide custom screens for share and action activities that users of iOS devices can use in the browser (e.g., browser 118) and other applications installed on the device. FIGS. 10A and 10B provide examples of shared activity screens. In some examples, extension/plugin 120 may be installed as an independent plugin, which may be activated from the list of browser extensions.

Extension/plugin 120 may include a product image extractor 122, a share service 124, and an authentication service 126. In brief overview, the product image extractor 122 may identify a product image (or other desired image) from among a plurality of images contained in the requested webpage when a user requests to save or share the webpage containing the product image, and selects the application providing the save or share function (collectively referred to hereinafter as a share action). The recommendation function may provide a link to the application/web server 106 to enable or enhance the functionality of the extension/plugin 120. For example, when a user selects a share action of a webpage including a product image, the share service 124 may be invoked to communicate and exchange data with the application/web server 106 over the communications network 108, for example, such as to save a selected product image, and/or to recommend a product webpage containing the selected product image to another user. In other words, the share service 124 may request user information and data from the application/web server 108, and may provide user inputs to the application/web server 108. Share service 124 communicates with application/web server 106 by using authentication service 126. Authentication service 126 helps ensure a user is authenticated to access the application/web server 106. Authentication service 126 both helps with authenticating a user of user device 102, and authorizes the user to save a selected product image or share with another user. The product image extractor 122, the share service 124, and the authentication service 126 will be described in more detail below.

The webpage server 104 may host webpages that are managed by a third-party content provider. In some embodiments, the webpage server 104 may host webpages that are managed by various different third-party content providers, for example, such as a web host, or may be a webpage server located at a data center of a particular third-party content provider to host webpages of the particular third-party content provider. The webpage server 104 may host and serve various webpages that are managed by one or more third-party content providers, and may provide the webpages to the browser 118 over the communications network 108 upon request (e.g., HTTP GET via a URL or other suitable link).

The application/web server 106 may include one or more application servers, web servers, data stores, and/or the like, and may facilitate the various processes and/or functionalities of the extension/plugin 120. In some embodiments, the application/web server 106 may host an application page, a webpage, a dashboard, a user interface, and/or the like that may be accessible via the browser 118 or a separate application installed on the user device 102 to enable the user to manage interactions with the extension/plugin 120 and/or other users. For example, the application page, the webpage, the dashboard, the user interface, and/or the like may provide an interface to the user to manage saved product images that have been collected from various webpages, revisit various product webpages containing the saved product images (e.g., via a URL or other suitable link), manage collections (e.g., categories or containers of saved product images), review recommendations, communicate with other users, manage friends (e.g., potential recommendees), and/or the like. In some embodiments, the application/web server 106 may manage and store various user information and data, and may provide the user information and data to the extension/plugin 120.

The communication interface 128 may be or include wired or wireless communications interfaces (e.g., jacks, antennas, transmitters, receivers, transceivers, wire terminals, and/or the like) for conducting data communications with the webpage server 104 and/or the application/web server 106. In various embodiments, communications via the communication interface 128 can be direct (e.g., local wired or wireless communications) or via the communications network 108 (e.g., a WAN, the Internet, a cellular network, and/or the like). For example, the communication interface 128 may include a Wi-Fi transceiver for communicating via a wireless communications network. In another example, the communication interface 128 may include an Ethernet card and port for sending and receiving data via an Ethernet-based communications link or network. In another example, the communication interface 128 may include cellular or mobile phone communications transceivers. In various embodiments, the communication interface 128 may support various suitable protocols (e.g., TCP/IP, User Datagram Protocol UDP, Hypertext Transfer Protocol HTTP, Internet Message Access Protocol IMAP, Simple Mail Transfer Protocol SMTP, and/or the like) and/or data communication interfaces (e.g., Application Program Interface API, Web Services, and/or the like) for facilitating data communications with the webpage server 104, the application/web server 106, and/or the like.

The communications network 108 may include any suitable wired or wireless network (e.g., a Local Area Network (LAN), a Wide Area Network (WAN), cellular communications network, and/or the like). For example, the network 108 may include Frequency Division Multiple Access (FDMA), Time Division Multiple Access (TDMA), Code Division Multiple Access (CDMA) (e.g., Evolution-Data Optimized (EVDO)), Universal Mobile Telecommunications Systems (UMTS) (e.g., Time Division Synchronous CDMA (TD-SCDMA or TDS)), Wideband Code Division Multiple Access (WCDMA), Long Term Evolution (LTE), evolved Multimedia Broadcast Multicast Services (eMBMS), High-Speed Downlink Packet Access (HSDPA), Universal Terrestrial Radio Access (UTRA), Global System for Mobile Communications (GSM), Code Division Multiple Access 1× Radio Transmission Technology (1×), General Packet Radio Service (GPRS), Personal Communications Service (PCS), 802.11X, Wi-Fi, any suitable wired network, combinations thereof, and/or the like.

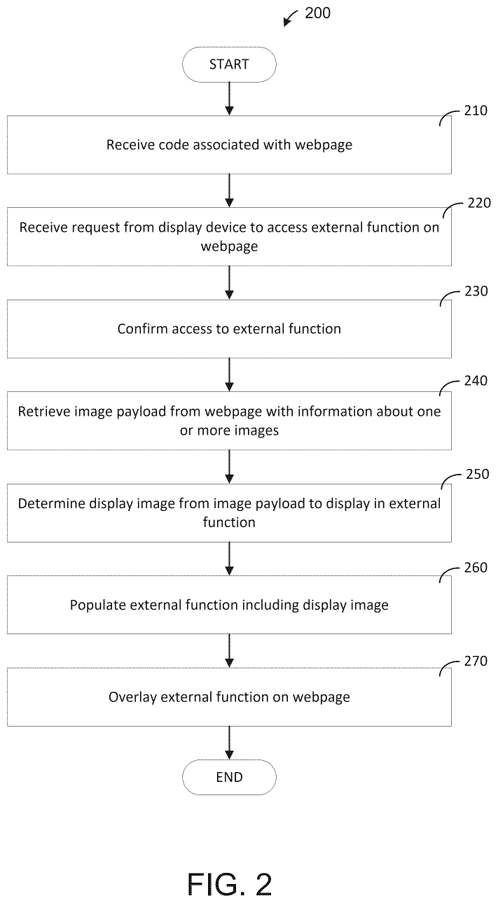

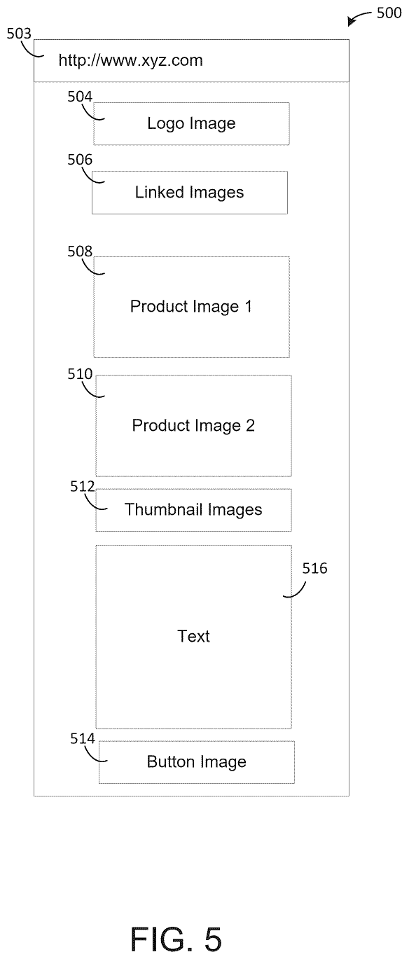

FIG. 2 illustrates a flow diagram of a method of accessing a sharing function for a product listed on a requested webpage according to one or more embodiments of the present disclosure. FIG. 5 illustrates a schematic diagram of a webpage as rendered on a user device according to one or more embodiments of the present disclosure. FIG. 10A illustrates a schematic diagram of a flow of a share functionality on a webpage according to one or more embodiments of the present disclosure.

Method 200, as shown in FIG. 2, may be performed, for example, by the share service 124 of the browser extension/plugin 120 shown in FIG. 1. However, the present disclosure is not limited thereto, and the operations shown in the method 200 may be performed by any suitable one of the components and elements or any suitable combination of the components and elements of those of one or more example embodiments described above. Further, the present disclosure is not limited to the sequence or number of the operations of method 200, as shown in FIG. 2, and can be altered into any desired sequence or number of operations as recognized by a person having ordinary skill in the art. For example, in some embodiments, the order may vary, or method 200 may include fewer or additional operations. Further, the operations shown in method 200 may be performed sequentially, or at least some of the operations thereof may be performed concurrently (e.g., simultaneously or substantially simultaneously).

Referring to FIGS. 2, 5, and 10A, method 200 may start, and code associated with a requested webpage 500 may be received at block 210. For example, in some embodiments, the browser 118 may communicate with a webpage server 104 to request the code (e.g., the HTML and/or XML) associated with the webpage 500, for example, in response to a user of the user device 102 providing a URL or IP address associated with the webpage 500 in a browser bar or search bar 402 of the browser 118. As such, the product image extractor 122 may receive the code (e.g., via HTTP POST) from the webpage server 104 at block 210.

The webpage 500 may include various images 504, 506, 508, 510, 512, and 514, and text 516. The webpage 500 may further include other content, for example, such as videos, audio, buttons, links, and/or the like. The images 504, 506, 508, 510, 512, and 514 may be included in the code as URLs or other suitable links, such that the browser 118 when translating the code may retrieve each of the images 504, 506, 508, 510, 512, and 514 according to their URLs or other links.

Upon rendering the webpage based on the code received in block 210, there is an option to receive various actions, including a request to access an external function, while on the webpage 500 at block 220. For example, in some embodiments, browser 118 may present action elements 1011-1014 to perform various actions on the webpage 500 rendered in scenario 1010, as shown in FIG. 10A. A request for accessing an external function may be performed by selecting the share action button 1013. In some embodiments, a standardized screen offering various sharing options, including an application associated with extension/plugin 120, may be presented to a user of user device 102. A user may then select the extension/plugin 120 option to cause a request to access an external function (e.g., the share function) at block 220.

In response to receiving a request to access an external function at block 220, a check is performed to confirm the requesting user is authorized to access the external function. For example, the authentication service 126 may verify whether the user making a request to access the external function is authenticated to access the information of the external function. Authentication service 126 may check for an authentication token of an active session to access the external function. Upon confirmation of an active session, block 220 begins the process of setting up a user interface (UI) for the external function by showing a successful message to load the external function. For example, user device 120, upon selecting share action button 1013, transitions from scenario 1010 to scenario 1020, showing confirmation of access to the external function using the message “Loading External Function” on a share loading screen 1021. However, the present disclosure is not limited thereto, and in some embodiment, scenario 1020 may be omitted as needed or desired.

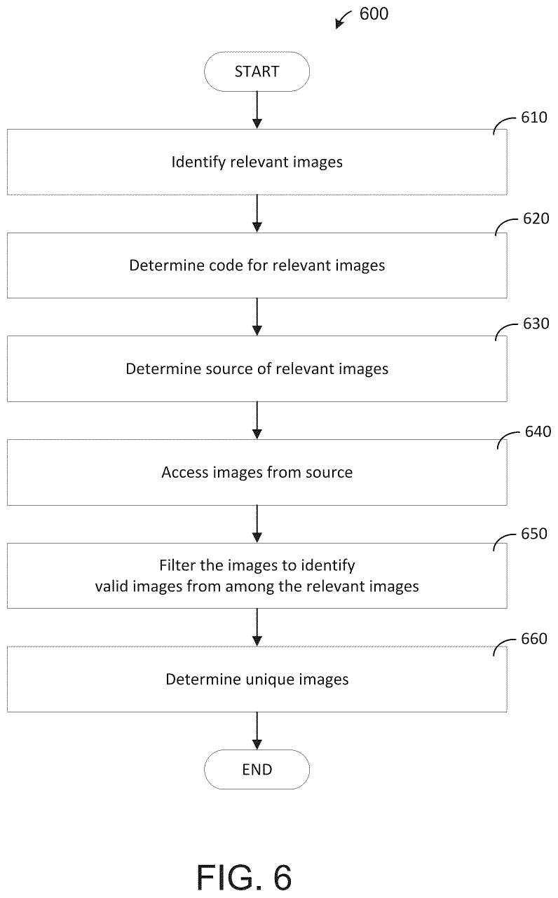

In response to receiving the confirmation to access the external function at block 220, method 200 retrieves an image payload from webpage 500 with information about one or more images. For example, the plurality of images 504, 506, 508, 510, 512, and 514 contained in webpage 500 may be identified and made part of the image payload at block 240. For example, the product image extractor 122 may identify each of the images 504, 506, 508, 510, 512, and 514 via a corresponding image tag, attribute, image file extension, and/or the like contained in the code. For example, as will be described in more detail below with reference to FIGS. 6 through 9B, the product image extractor 122 may identify the product images (also referred to as display images) 508 and 510 from among the images 504, 506, 508, 510, 512, and 514 contained in the code of the webpage to include in the image payload.

In order to retrieve the image payload including the product images 508 and 510 from among the images 504, 506, 508, 510, 512, and 514 contained in the webpage 500, images 504, 506, 508, 510, 512, and 514 may be filtered to identify display images (e.g., 508 and 510) from among the images 504, 506, 508, 510, 512, and 514 at block 250.

In some embodiments, retrieving the image payload includes determining multiple sets of images on webpage 500. For example, in some embodiments, product image extractor 122 may determine a first set of images in the webpage that are viewed by a user on the display device 110 of the user device 102. In other embodiments, a second set of images that may not be visible, but are present on the webpage 500, may be included as part of the image payload. Product image extractor 122 may determine the second set of images when the first set of images visible to the user in the webpage 500 is empty, or the number of images is below a certain threshold value. In some embodiments, product image extractor 122 may determine a second set of images, if the first set of images does not meet a size and quality threshold.

In response to determining the display image (e.g., the product images 508 and 510) from among the images 504, 506, 508, 510, 512, and 514 contained in the webpage 500 at block 250, the external function is populated using the display image at block 260. For example, in some embodiments, the share service 124 may overlay the share screen 1031 representing the Ul for the external function shown in scenario 1030 of FIG. 10A. The display images 508 and 510 may be included as a preview image 1032. Share screen 1031, representing the Ul for the external function, is populated with other information retrieved as part of the image payload at block 240.

The share screen 1031 representing the Ul for the external function may be displayed on the user device 102 of a requestor of the webpage 500 at block 270, and the method 200 may end. For example, the browser 118 may display the webpage 500, including the overlaid share screen 1031 representing the Ul for the external function on the display device 110 associated with the user device 102, at block 270.

The sharing screen 1031 forming the Ul for the external function may further enable a user to save a product image of a product webpage for later retrieval. When the user clicks on the save link 1034, a link of the product image 1032 and/or a link of the product webpage 402 may be transmitted (e.g., by the share service 124) to be saved to the user's account with the application/web server 106. When the user clicks on or hovers over the collection dropdown 1036, the user may save the product image and/or the link of the product webpage in a particular collection. The collections may be predefined and/or user-defined, and may enable the user to organize the saved product images into different categories as needed or desired.

In various embodiments, as briefly described above, the product image extractor 122 may identify the product images 508 and 510 from among the images 504, 506, 508, 510, 512, and 514 contained in the code of the webpage by using various suitable methods, for example, such as according to method 600, 700, and 800 as shown in FIGS. 6 through 8, described in more detail below.

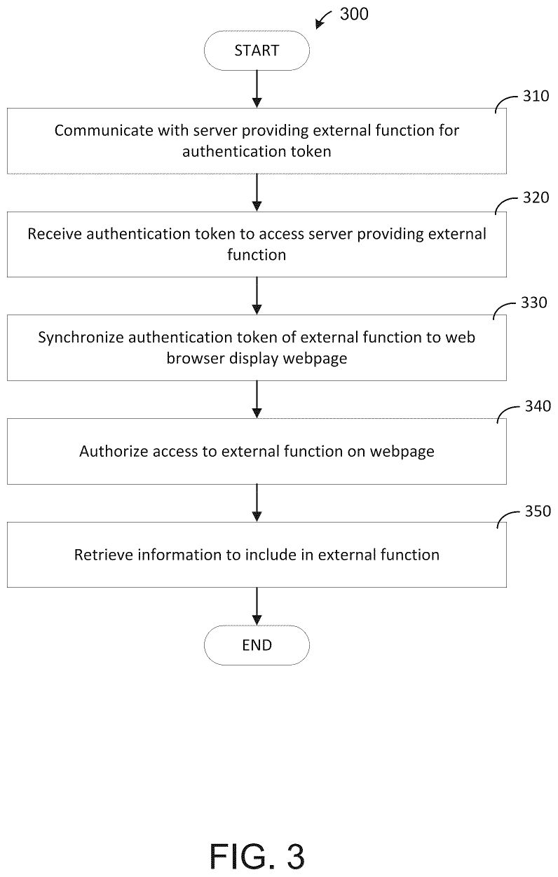

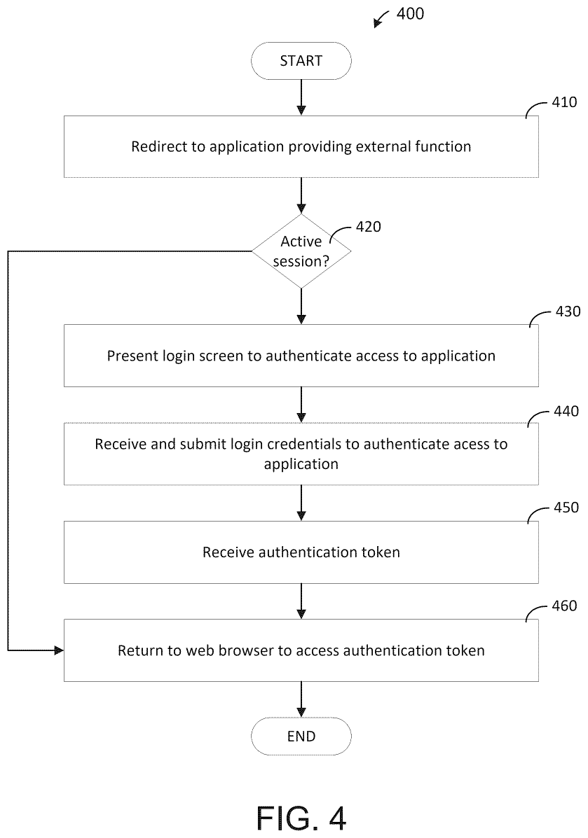

FIG. 3 illustrates a flow diagram of a method of confirming access to an external function according to one or more embodiments of the present disclosure. FIG. 4 illustrates a flow diagram of a method of obtaining access to an external function according to one or more embodiments of the present disclosure. FIG. 10B illustrates a schematic diagram of a flow of a share functionality on a webpage according to one or more embodiments of the present disclosure.

FIGS. 3 and 4 illustrate flow diagrams of methods 300 and 400 for confirming and obtaining access to the external function according to one or more embodiments of the present disclosure. Methods 300 and 400, as shown in FIGS. 3 and 4, respectively, may be performed, for example, by the authentication service 126 of the browser extension/plugin 120 shown in FIG. 1. However, the present disclosure is not limited thereto, and the operations shown in methods 300 and 400 may be performed by any suitable one of the components and elements or any suitable combination of the components and elements of those of one or more example embodiments described above. Further, the present disclosure is not limited to the sequence or number of the operations of methods 300 and 400, as shown in FIGS. 3 and 4, and can be altered into any desired sequence or number of operations as recognized by a person having ordinary skill in the art. For example, in some embodiments, the order may vary, or the methods 300 and 400 may include fewer or additional operations. Further, the operations shown in methods 300 and 400 may be performed sequentially, or at least some of the operations thereof may be performed concurrently (e.g., simultaneously or substantially simultaneously).

Referring to FIG. 3, method 300 may start with a communicate with server 106 for an authentication token at block 310. Server 106 provides the external function, and allows access to the external function using an authentication token. For example, in some embodiments, authentication service 126 may communicate with application server 106 associated with the external function (e.g., the share function) in response to a user of the user device 102 selecting the share action button 1013 in method 200 at block 220. The processes of method 300 may be performed as part of a confirmation to access an external function at block 230 in method 200.

In response to the communication with the server 106 at block 310, an authentication token may be retrieved to access the server 106 that provides the external function (e.g., the sharing function) at block 320. For example, in some embodiments, authentication service 126 may receive an authentication token to access the application server 106 for information needed for accessing the external function. The information needed may include code for the external function and other text and graphics used to populate the Ul for the external function. The code for the external function may include code for the user interface to call the external function, and a function (e.g., an application programming interface API) to access the external function. Authentication service 126 may receive an authentication token via communication interface 128. In some other embodiments, the authentication token may reside locally on the user device 102, and be managed by a different application that is used with the application server 106.

In response to receiving an authentication token at block 330, authentication service 126 may synchronize the authentication token to web browser 118 at block 330. For example, authentication service 126 may synchronize the authentication token with the web browser 118 by copying the authentication token to a private keychain accessible to (e.g., only to) the extension/plugin 120 and not to the web browser 118. For example, the private keychain may be an operating system provided feature to store secrets, such as passwords and other encrypted keys, to access devices. Sharing system 100 avoids storing the authentication token in the cookie section of the web browser 118 as it could lead to security issues, such as allowing access to other websites and application servers other than application/web server 106 having access to the authentication token. The authentication token is stored in the private keychain, which is private and secure, by limiting access to (e.g., only to) the extension/plugin 120 and application/web server 106. The web browser 118 provides the images which are recognized and extracted by product image extractor 122, and the authentication token is handled by the authentication service 126. In some embodiments, authentication service 126 may refresh the authentication token based on a trigger, such as a timer, or may request to access the external function.

In some embodiments, upon receiving the authentication token signifying a successful authentication, the user device 102 may transition from scenario 1010 to scenario 1020, as shown in FIG. 10A, and may display a share loading screen 1021 showing the message “Loading External Function.” User device 102 continues to display share loading screen 1021 of scenario 1020 until it is ready to display the user interface (UI) for accessing the external function. Of course, in other embodiments, the share loading screen 1021 may be omitted, and the share screen 1031 may be displayed instead.

Upon synchronizing the authentication token at block 330, authentication service 126 may authorize access to the external function on webpage 500 at block 340 of method 300. For example, application server 106 may offer multiple functions, including the external function, which is used to save and share information about a product on the webpage 500 displayed by the web browser 118.

Upon synchronizing the authentication token block 340, authentication service 126 may retrieve information to include in the external function at block 330, and the method 300 may end. In some embodiments, the user device 102 may transition out of scenario 1020 upon completion of the execution of method 300. For example, user device 102 may transition from scenario 1020 with the share loading screen 1021 to scenario 1030 with the share screen 1031, presenting the UI for the external function whose access was authenticated in method 300.

Referring to method 400 of FIG. 4 and FIG. 10B, upon requesting to confirm access to the external function at block 230, authentication service 122 running on user device 102 may redirect it to an application providing the external function to authenticate and gain access to the external function at block 410. For example, in some embodiments, authentication service 126 may communicate with application server 106 associated with the external function in response to a user of the user device 102 selecting the share action button 1013 in the method 200 at block 220. Processes of method 400 may be performed as part of the communicating with the application server 106, which provides the external function to receive an authentication token at block 310 in the method 300. Authentication service 126 may determine that there is no active session to application server 106 to access the external function. Authentication service 126 may then redirect to the application served by application server 126 to authenticate a user of user device 102.

In response to the redirection, at block 410, authentication service 126 executing method 400 verifies whether or not there is an active session at block 420. An active session is present if a user of the user device 102 has previously logged in and the session has not yet timed out, or was not made explicitly inactive. An active session may be represented by a user of the user device logged in to access application server 106. Additionally, an active session requires an application running on the user device 102 used to communicate with the application server 106.

If the result of a check for an active session is a failure (e.g., No N) at block 420, then method 400 moves to execute block 430. Otherwise, method 400 will jump to block 460. For example, user device 102 transitions to scenario 1050, displaying share screen 1051 upon determining there is no active session, and the user needs to authenticate to access the external function.

Upon determining that there is no active session at block 420, a login screen to authenticate access to the application is presented at block 430. For example, user device 102 may present scenario 1050 upon determining that there is no active session, and then may transition from scenario 1050 to scenario 1060 of FIG. 10B by switching to open the application, providing the external function.

In block 440, login credentials are received and submitted on the user's device to the login UI 1061 in scenario 1060 of FIG. 10B. In some embodiments, a user of the user device may provide the login credentials received by the device and submitted by the user by clicking the “login” button 1062 in application UI 1061. Authentication service 126 may receive and submit login credentials to authenticate access to the external function provided by the application.

In response to submitting the login credentials at block 440, user device 102 may receive an authentication token at block 450.

Upon receiving the authentication token 102, at block 450, user device 102 may return to the web browser 118 to access the authentication token, and method 400 may end. For example, upon completion of the execution of method 400, the execution may jump back to method 300 at block 320 to continue setting up the requested external function.

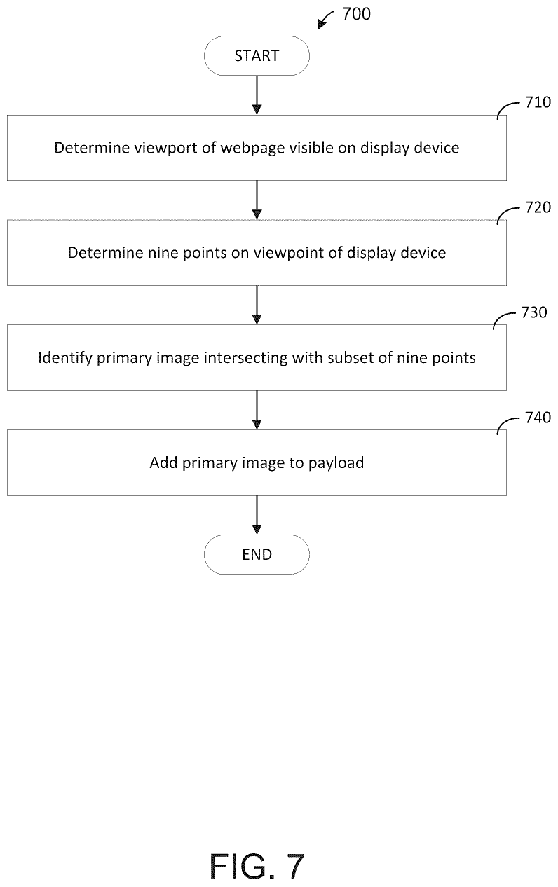

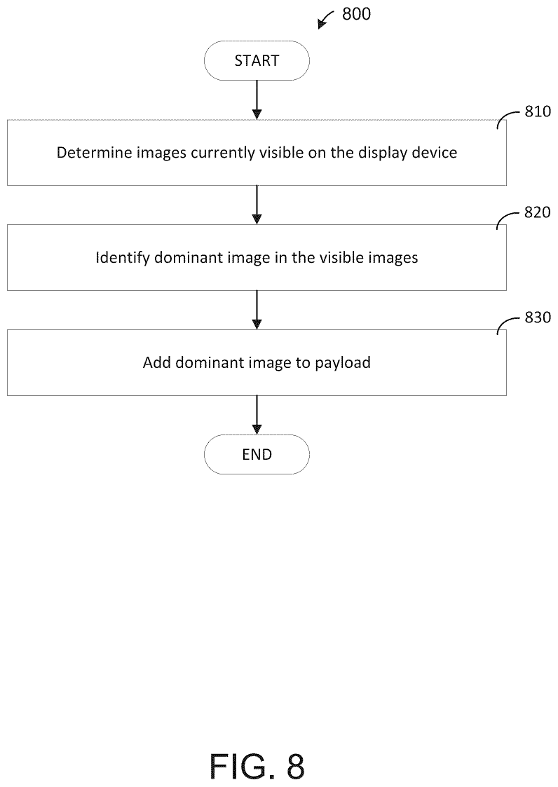

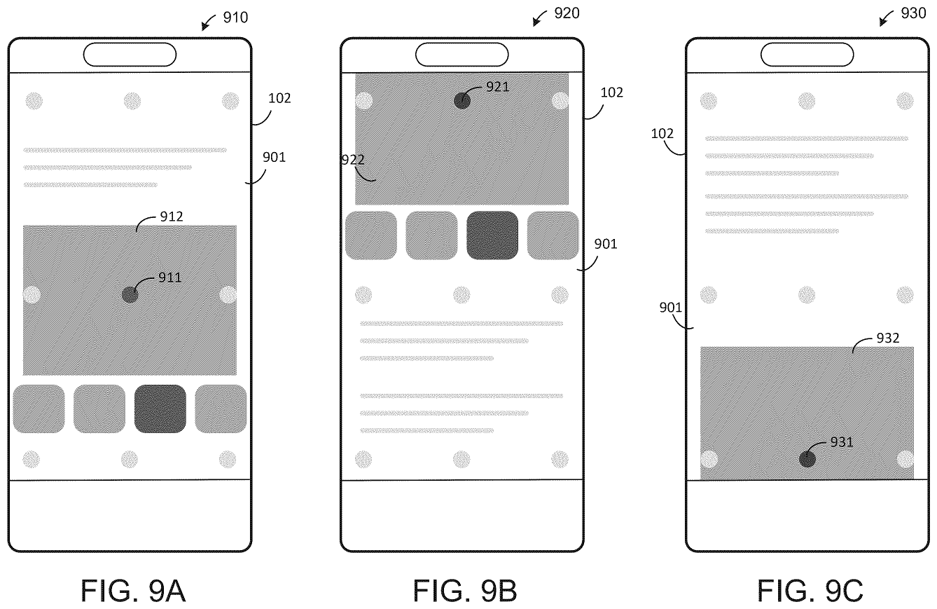

FIG. 6 illustrates a flow diagram of a method of accessing images of a product on a webpage to share according to one or more embodiments of the present disclosure. FIG. 7 illustrates a flow diagram of a method of identifying images on a webpage visible on a device according to one or more embodiments of the present disclosure. FIG. 8 illustrates a flow diagram of a method of identifying images on a webpage according to one or more embodiments of the present disclosure. FIGS. 9A-9C illustrate variations of a nine-point technique for identifying images of a product on a webpage requested to be shared according to one or more embodiments of the present disclosure. In methods 600, 700, and 800, operations or processes that are the same or substantially the same as those described above with reference to method 200 of FIG. 2 are designated with the same reference symbols, and thus, redundant description thereof may not be repeated.

Methods 600, 700, and 800, as shown in FIGS. 6 through 8, may be performed, for example, by the product image extractor 122 of the browser extension/plugin 120 shown in FIG. 1. However, the present disclosure is not limited thereto, and the operations shown in the methods 600, 700, and 800 may be performed by any suitable one of the components and elements or any suitable combination of the components and elements of those of one or more example embodiments described above. Further, the present disclosure is not limited to the sequence or number of the operations of the methods 600, 700, and 800, as shown in FIGS. 6 through 8, and can be altered into any desired sequence or number of operations as recognized by a person having ordinary skill in the art. For example, in some embodiments, the order may vary, or the methods 600, 700, and 800 may include fewer or additional operations. Further, the operations shown in methods 600, 700, and 800 may be performed sequentially, or at least some of the operations thereof may be performed concurrently (e.g., simultaneously, or substantially simultaneously).

Referring to the method 600 of FIG. 600, in some embodiments, the retrieving of the image payload at block 240 of the method 200 may include identifying each of the images 504, 506, 508, 510, 512, and 514 at block 620. For example, in some embodiments, the product image extractor 122 may determine the portions of the code used to make images 504, 506, 508, 510, 512, and 514 viewable by a user of the user device 102 in the web browser 118.

In some embodiments, the determining of the portions of the code includes determining image elements, such as <IMG> tags, of the HTML code of the webpage 500 where the images are shown. In other embodiments, the product image extractor 122 may determine other elements, such as <DIV> tags, <BUTTON> tags, <SPAN> tags, and/or the like, in the HTML code with attributes set to show a background image. In some other embodiments, product image extractor 122 may determine the portion of the code used to display images from the shadow DOM elements generated by JavaScript used to append portions of HTML code in runtime based on user actions. For example, a user's action to select an image from a carousel may result in an image being expanded and visible on the webpage 500.

Upon determining the code for images at block 620, the location of images identifying the file source from where the image is accessed is determined at block 630. For example, product image extractor 122 may review the source attribute of image elements <IMG> to determine the portion of the code for an image matching the visible images determined at block 610. In some embodiments, the source attribute is empty, and the product image extractor 122 may identify alternative attributes used for storing source information of the images determined at block 610. For example, product image extractor 122 may review fallback sources for images in other attributes, such as data-src, data-zoom-src, data-img, srcset, and/or the like, included in the image element or other HTML elements. After identifying the file sources of the images at block 630, product image extractor 122 accesses them by downloading them to the user device to a cache accessible in the web browser 118 by share service 124. In some embodiments, product image extractor 122 accesses a local copy of the images downloaded as part of rendering webpage 500 in the web browser 118.

Upon accessing the images at block 640 using the sources identified at block 630, product image extractor 122 may filter for (e.g., only for) visible and valid images at block 650. In some embodiments, any images that have been part of the HTML code but have a hidden attribute set to true may considered invisible and ignored. In other embodiments, images used on buttons or other non-image tags may be considered to be invalid images. In some other embodiments, images that are smaller than a certain size may not be considered to be valid images to use by the share service 124 to help populate the Ul for the external function.

In block 660, product image extractor 122 identifies unique images among the visible and valid images filtered at block 650, and method 600 may end. Determining the unique images may result in the same image of various sizes being ignored, even if they are valid. For example, the same image in zoomed-in mode and zoomed-out mode may be flagged for unique images.

Upon completion of the execution of method 600, it may return to block 250 of the method 200 with the determined relevant and valid images as part of the image payload processed by the method 200.

Referring to FIGS. 7 and 9A through 9C, method 700 may start, and viewport 901, as shown in FIG. 9A, of webpage 500 and visible on display device 110 of user device 102 is identified by the product image extractor 122. In some embodiments, software on the user device 102, such as web browser 118, operating system, or other system software, may help identify the viewport of the webpage 500 as visible on the display device 110. Product image extractor 122 may work with system software to identify the viewport of the webpage 500.

Upon determining the viewport 901 of the webpage 500 at block 710, product image extractor 122 may determine nine points on viewport 901 of the display device 110, as shown in FIGS. 9A through 9C. In some embodiments, the nine points may be placed on the viewport 901, starting with the four corners of the viewport 901, the four points in between the four corners, and one point at the center of the viewport 901.

Upon determining and placing the nine points on the viewport 901 at block 720, product image extractor 122 may identify the primary image at block 730. For example, in some embodiments, as shown in FIG. 9A, the primary image 912 may be identified based on the center point 911 in the nine points aligning with an image. In other embodiments, as shown in FIGS. 9B and 9C, primary images 922 and 932 may be identified based on any center points 921 and 931 in a series of horizontal points. FIGS. 9B and 9C may determine the same primary image 912 as the primary image 922 or 932 when the web page is scrolled in either direction, causing a portion of the image to be beyond the boundary of the display device 110 and not visible to a user of user device 102. In some other embodiments, the primary image may be identified based on the number of points in the nine points in viewport 901. For example, if a majority of points in the nine points on the viewport 901 are within the boundaries of an image, then it is regarded as a primary image. In other embodiments, if the number of points in the nine points overlapping an image exceeds a threshold value, then it is regarded as a primary image.

Upon identifying a primary image at block 730, product image extractor 122 may add the identified primary image to an image payload at block 740. The image payload, including the identified primary image, is used to populate the Ul for the external function at block 260 in the method 200, which is used to access the external function.

In some embodiments, product image extractor 122 may determine a set of images to include as the display images to populate the external function. For example, selected image 1032 may include a list of images for a user to select an image to save and/or share. In some embodiments, the external function may allow saving and/or sharing of a set of images. Product image extractor 122 may list images for selection in the order they were identified on webpage 500. In some embodiments, product image extractor 122 may order the determined set of images by size, quality, or other suitable factors distinguishing the images.

Upon completion of the execution of method 700, it may return to block 610 with the determined primary image as the relevant image to include in the image payload processed by the method 200.

Referring to FIG. 8, method 800 may start, and product image extractor 122 may identify images of webpage 500 currently visible on the display device 110. Among images 504, 506, 508, 510, 512, and 514 present on page 500, a subset of images may be visible on display device 110. Product image extractor 122 may determine the viewport (e.g., viewport 901 as shown in FIGS. 9A through 9C) to identify the currently visible images on the display device 110.

Upon identifying visible images at block 810, product image extractor 122 may identify a dominant image among them at block 820.

At block 830, the dominant image from block 820 is added to the payload. The image payload, including the identified dominant image, is used to populate the external function at block 260 in method 200 used to access the external function.

Upon completion of the execution of method 800, it may return to block 610 with the determined primary image as a relevant image to include in the image payload processed by method 200.

Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A system for accessing an external function on a webpage, comprising:
one or more processors; and
memory communicably connected to the one or more processors and storing instructions that, when executed by the one or more processors, cause the one or more processors to:
receive a request from a user device to access the external function on the webpage;
confirm access to the external function by:
communicating with a server providing the external function for an authentication token;
receiving an authentication token used to access the server providing the external function;
synchronizing the authentication token of the external function to a web browser displaying the webpage;
authorizing access to the external function on the webpage; and
retrieving information from the server to include in the external function;
retrieve an image payload from the webpage, the image payload comprising information related to one or more images;
determine a display image from the image payload to display in the external function;
populate the external function using the display image and the information from the server; and
overlay the external function on the webpage.

2. The system of claim 1, wherein to retrieve the image payload from the webpage, the instructions further cause the one or more processors to:
determine a first set of images in the webpage displayed on the user device;
determine a second set of one or more images presented on the webpage displayed in the web browser; and
add the first set and second set of one or more images to the image payload.

3. The system of claim 2, wherein to determine the first set of images in the webpage displayed on the user device, the instructions further cause the one or more processors to:
determine a viewport of the webpage as visible on the user device;
determine nine points on the viewport to identify a primary image visible in the viewport of the user device;
identify a primary image intersecting with one or more of the nine points on the viewport of the user device; and
add the primary image to the first set of one or more images.

4. The system of claim 1, wherein to determine the display image from the image payload to display in the external function, the instructions further cause the one or more processors to:
determine code in the webpage to display the one or more images in the image payload;
determine file sources of each image of the one or more images in the code, the file sources identifying locations of files representing each image of the one or more images;
access the one or more images from the file sources;
validate each image of the one or more images by reviewing an image size and a visibility of the image;
de-duplicate the validated images by determining whether each image is a duplicate of any previously validated images; and
determine the display image from the de-duplicated images.

5. The system of claim 4, wherein to determine the code in the webpage to display the one or more images in the image payload, the instructions further cause the one or more processors to:
determine image elements of an HTML code of the webpage where the one or more images are located;
determine other elements of the HTML code of the webpage which sets background image attributes where the one or more images are located; and
determine elements of a hidden portion of the HTML code of the webpage present where the one or more images are located,
wherein the hidden portion of the HTML code is a dynamically generated code.

6. The system of claim 5, wherein to access the one or more images from the file sources, the instructions further cause the one or more processors to:
determine source attribute of the image elements of the HTML code of the webpage where the one or more images are located; and
in response to the source attribute being empty, determine alternative attributes representing the file sources.

7. The system of claim 1, wherein the request from the user device to access the external function on the webpage is received in response to a user of the user device selecting a share operation.

8. The system of claim 1, wherein to communicate with the server providing the external function for an authentication token, the instructions further cause the one or more processors to:
redirect to an application providing the external function; and
in response to no active login session to the application:
present a login screen to authenticate access to the application;
receive and submit login credentials to authenticate access;
receive an authentication token; and
return to the web browser to access the authentication token.

9. The system of claim 8, wherein to synchronize the authentication token of the external function to the web browser displaying the webpage, the instructions further cause the one or more processors to copy the authentication token to a private keychain accessible to the application and the external function.

10. The system of claim 1, wherein to determine the display image from the image payload to display in the external function, the instructions further cause the one or more processors to:
prepare a third set of images included in an order in which they were determined from the webpage;
provide a function to select an image from the third set of images; and
display a first image in the third set of images.

11. A method for accessing an external function on a webpage, comprising:
receiving, by a processor, a request from a user device to access the external function on the webpage;
confirming, by the processor, access to the external function by:
communicating with a server providing the external function for an authentication token;
receiving an authentication token used to access the server providing the external function;
synchronizing the authentication token of the external function to a web browser displaying the webpage;
authorizing access to the external function on the webpage; and
retrieving information from the server to include in the external function;
retrieving, by the processor, an image payload from the webpage comprising information related to one or more images;
determining, by the processor, a display image from the image payload to display in the external function;
populating, by the processor, the external function using the display image and the information from the server; and
overlaying, by the processor, the external function on the webpage.

12. The method of claim 11, wherein the retrieving of the image payload from the webpage comprises:
determining, by the processor, a first set of images in the webpage displayed on the user device;
determining, by the processor, a second set of one or more images presented on the webpage displayed in the web browser; and
adding, by the processor, the first set and second set of one or more images to the image payload.

13. The method of claim 12, wherein the determining of the first set of images in the webpage viewed by a user of the user device comprises:
determining, by the processor, a viewport of the webpage as visible on the user device;
determining, by the processor, nine points on the viewport to identify a primary image visible in the viewport of the user device;
identifying, by the processor, a primary image intersecting with one or more of the nine points on the viewport of the user device; and
adding, by the processor, the primary image to the first set of one or more images.

14. The method of claim 11, wherein the determining of the display image from the image payload to display in the external function comprises:
determining, by the processor, code in the webpage to display the one or more images in the image payload;
determining, by the processor, file sources of each image of the one or more images in the code, the file sources identifying locations of files representing each image of the one or more images;
accessing, by the processor, the one or more images from the file sources;
validating, by the processor, each image of the one or more images by reviewing an image size and visibility of the image;
de-duplicating, by the processor, the validated images by determining whether each image is a duplicate of any previously validated images; and
determining, by the processor, the display image from the de-duplicated images.

15. The method of claim 14, wherein the determining of the code in the webpage to display the one or more images in the image payload comprises:
determining, by the processor, image elements of an HTML code of the webpage where the one or more images are located;
determining, by the processor, other elements of the HTML code of the webpage which sets background image attributes where the one or more images are located; and
determining, by the processor, elements of a hidden portion of the HTML code of the webpage present where the one or more images are located,
wherein the hidden portion of the HTML code is a dynamically generated code.

16. The method of claim 15, wherein the accessing of the one or more images from the file sources further comprises:
determining, by the processor, source attribute of the image elements of the HTML code of the webpage where the one or more images are located; and
in response to the source attribute being empty, determining, by the processor, alternative attributes representing the file source.

17. The method of claim 11, wherein the receiving of the request from the user device to access the external function on the webpage is in response to a user of the user device selecting a share operation.

18. The method of claim 11, wherein the communicating with the server providing the external function for an authentication token comprises:
redirecting, by the processor, to an application providing the external function; and
in response to no active login session to the application:
presenting, by the processor, a login screen to authenticate access to the application;
receiving and submitting, by the processor, login credentials to authenticate access;
receiving, by the processor, an authentication token; and
returning, by the processor, to the web browser to access the authentication token.

19. The method of claim 18, wherein the synchronizing of the authentication token of the external function to the web browser displaying the webpage comprises copying, by the processor, the authentication token to a private keychain accessible to the application and the external function.

20. The method of claim 11, wherein the determining of the display image from the image payload to display in the external function comprises:
preparing, by the processor, a third set of images included in an order in which they were determined from the webpage;
providing, by the processor, a function to select an image from the third set of images; and
displaying, by the processor, a first image in the third set of images.
